(19) United States
(12) Patent Application Publication
(10) Pub. No.: US 2026/0278416 A1
(43) Pub. Date: Sep. 17, 2026

(54) CONTENT GENERATION SYSTEM USING SPECIALIZED GUIDED AND CONSTRAINED ARTIFICIAL INTELLIGENCE WORKERS AND DYNAMIC KNOWLEDGE INTEGRATION

(71) Applicant: 2hr Learning, Inc., Austin, TX (US)

(72) Inventors: Rahul Subramaniam, Chennai (IN); Samy Aboel-Nil, Austin, TX (US); Vinayak Sachdeva, Haryana (IN)

(73) Assignee: 2hr Learning, Inc., Austin, TX (US)

(21) Appl. No.: 19/560,144

(22) Filed: Mar. 9, 2026

Related U.S. Application Data
(63) Continuation-in-part of application No. 19/560,006, filed on Mar. 7, 2026.
(60) Provisional application No. 63/771,478, filed on Mar. 13, 2025.
(60) Provisional application No. 63/771,460, filed on Mar. 13, 2025.

(51) Int. Cl. G06N 5/04; G06F 16/3329; G06F 18/21; G06N 5/022

(52) U.S. Cl. CPC G06N 5/04; G06F 16/3329; G06F 18/217; G06N 5/022

(57) ABSTRACT

A content generation system and method by guiding multiple AI workers through a structured and optimized workflow is disclosed. The content generation method begins with receiving a natural language input query from a user, which is processed to decompose the content creation task into specialized sub-tasks. Each sub-task is assigned to a corresponding AI worker equipped with personalized set of prompts designed by a prompt engineer. These AI workers utilize dynamic knowledge repositories, enriched with domain-specific insights and real-time external data sources, such as competitor content, trending topics, and audience feedback, to generate precise and relevant outputs. The sub-tasks are sequentially executed based on their dependencies, ensuring logical flow and coherence. The content generation system generates multi-format responses, including text, images, visualizations, and videos, optimized to meet user objectives.

### CROSS-REFERENCE TO RELATED APPLICATION(S)

This application claims the benefit under 35 U.S.C. § 119(e) and 37 C.F.R. § 1.78 of U.S. Provisional Application Nos. 63/771,460 and 63/771,478, which are incorporated by reference in their entireties.

This application is a continuation-in-part of U.S. patent application Ser. No. 19/560,006, which is incorporated by reference in its entirety.

### FIELD OF THE INVENTION

The present invention generally relates to the field of electronics and more specifically to a content generation system using specialized guided and constrained artificial intelligence workers and dynamic knowledge integration.

### BACKGROUND OF THE INVENTION

Traditional methods of AI-driven content generation often rely on single-step systems designed to create entire pieces of content in one go. While this approach simplifies the workflow, it frequently fails to meet the nuanced requirements of modern content creation. Content designed for platforms like social media requires precision, adaptability, and an understanding of diverse audience behaviors, which single-shot solutions struggle to achieve.

One of the significant limitations of these traditional approaches is their inability to incorporate specialized domain knowledge. Viral and impactful content often relies on specific expertise, such as understanding competitor strategies, audience preferences, and trends in a particular niche. Single-shot systems cannot include or apply such detailed insights effectively. This lack of depth leaves content disconnected from the factors that drive engagement and resonance.

Moreover, these systems are static and fail to integrate real-time performance data. Creating the content that stays relevant requires constant adaptation to trends, audience feedback, and shifting platform algorithms. Traditional systems do not account for metrics like engagement rates, viewership trends, or audience sentiment, resulting in content that quickly becomes outdated or fails to perform optimally.

Additionally, traditional methods lack the flexibility to identify and learn from successful and unsuccessful content attributes. Without iterative feedback loops or the ability to refine processes based on what works, these systems are unable to improve over time. As a result, content creators often find themselves compensating for the system's shortcomings with manual adjustments, which defeats the purpose of automation and adds inefficiency to the process.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary content generation system by guiding multiple AI workers.

FIG. 2 depicts an exemplary content generation process by guiding multiple AI workers.

FIG. 3 depicts an exemplary user interface disclosing a list of user-generated AI workers.

FIG. 4 depicts an exemplary user interface disclosing the generation of a new AI worker.

FIGS. 5 and 6 depict exemplary user interfaces showing the details provided by the user for idea outline and thumbnail generation using an idea outline generator and a thumbnail generator, respectively.

FIG. 7 depicts an exemplary user interface allowing users to select a channel for performing the task.

FIG. 8 depicts an exemplary user interface showing the response generated based on the details provided by the user to the AI worker.

FIG. 9 depicts an exemplary user interface disclosing the workflow of image generation and the connection between the AI workers.

FIG. 10 depicts an exemplary user interface showing the response generated based on the workflow disclosed in FIG. 9.

FIGS. 11-13 depict exemplary user interfaces showing the response generated for a viral video idea generation.

FIG. 14 depicts an exemplary user interface showing a thumbnail generated by the AI worker.

FIG. 15 depicts an exemplary network environment in which the content generation system of FIG. 1 and the content generation process of FIG. 2 may be practiced by guiding multiple AI workers.

FIG. 16 depicts an exemplary computer system.

### DETAILED DESCRIPTION

A content generation system to generate a response by guiding multiple AI workers is disclosed. Initially, the content generation system receives an input query from a user in the form of a natural language input, via, a user interface. The user interface is integrated into an online content generation platform. The input query is decomposed from a content creation task into a plurality of specialized sub-tasks using a task decomposing module. The task decomposing module is operatively coupled to the online content generation platform. Each sub-task is allocated to the corresponding AI worker. Further, a set of prompts is provided by a prompt engineer for each AI worker. The set of prompts is designed separately for each AI worker.

Additionally, a dynamic knowledge repository, referred to herein as a “second brain,” is utilized by each AI worker which includes domain-specific insights, and external data sources for content generation. A sub-task sequencing module sequentially handles each sub-task based on the dependencies between each AI worker. The sub-task sequencing module is integrated within the AI workers, operatively coupled to the task decomposing module. Finally, a response generator, operatively coupled to the AI workers generates a response for each sub-task in multiple formats by utilizing the set of prompts, the knowledge repository, and the external data sources.

The content generation system by guiding multiple AI workers offers advantages by decomposing content creation tasks into specialized sub-tasks handled by the AI workers, ensuring precision, adaptability, and optimized outputs. By utilizing dynamic knowledge repositories and real-time integration of external data sources, such as competitor insights, trending topics, and audience feedback, the content generation system by guiding multiple AI workers creates relevant and engaging content personalized to user objectives. Its iterative feedback loop and performance analysis capabilities enable continuous improvement by identifying high-performing attributes and excluding underperforming ones. The content generation system by guiding multiple AI workers is particularly advantageous for social media marketing, where viral and audience-specific content is crucial, as well as for industries like e-commerce, digital advertising, and content strategy. The content generation system by guiding multiple AI workers can also be applied to educational content creation, multimedia storytelling, and corporate communication, providing a solution for diverse content needs while maximizing efficiency and effectiveness.

The system and method set forth herein address technical issues with generating the desired outputs described herein. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its(their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

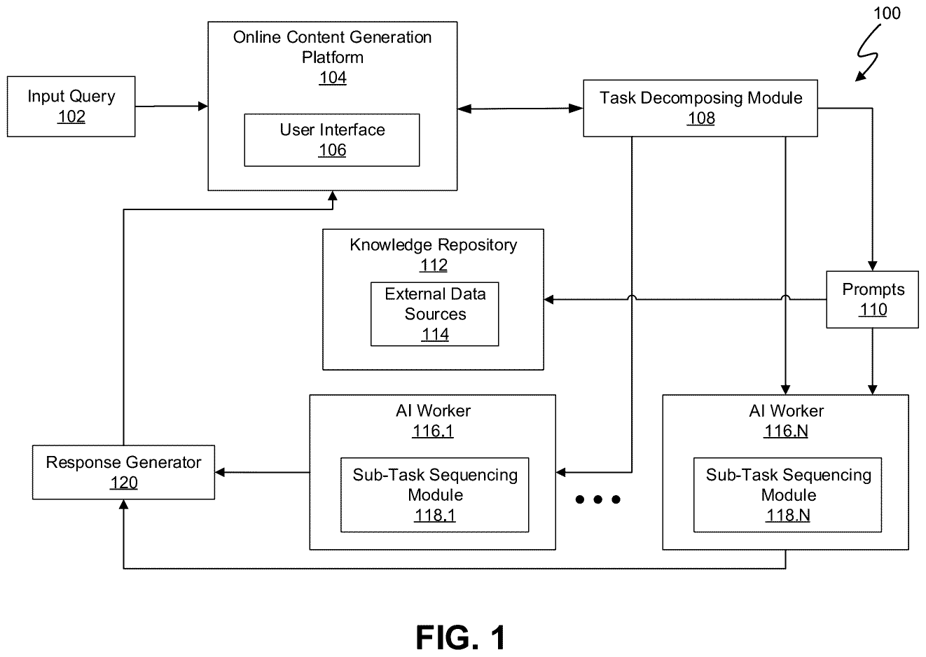

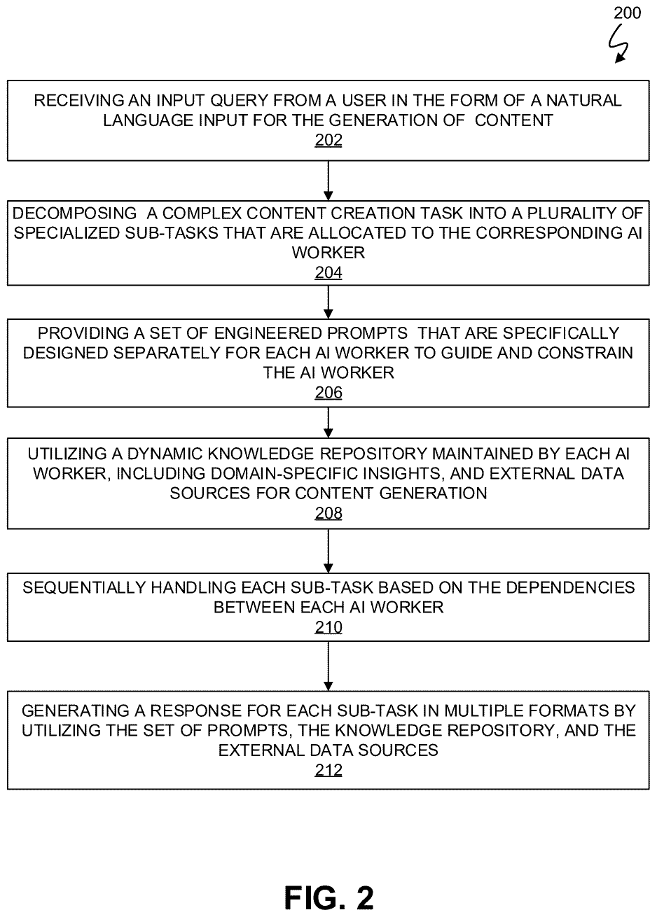

FIG. 1 depicts an exemplary content generation system 100 by guiding multiple AI workers 116.1-116.N, where Nis an integer equal to 2 or greater representing the number of AI workers. FIG. 2 depicts an exemplary content generation process 200 used to guide and constrain multiple AI workers 116.1-116.N. Reference to “AI worker 116” refers to each or every AI worker as indicated by context.

Referring to FIGS. 1 and 2, in operation 202, a user interface 106 receives an input query 102 from a user in the form of a natural language input to generate content. The user interface 106 acts as the primary point of interaction between the user and an online content generation platform 104. The user interface 106 is integrated into the online content generation platform 104. The online content generation platform 104 is a tool or service designed to help the users to create, manage, and distribute digital content for various purposes, such as marketing, education, entertainment, or personal expression. The user interface 106 is designed to receive the input query 102 from the user in the form of natural language inputs, enabling seamless and intuitive communication. By allowing users to phrase their requests naturally, the online content generation platform 104 eliminates the need for specialized knowledge or technical commands, making it accessible to a wide range of users, including those without technical expertise.

The input query 102 is entered directly into the user interface 106 integrated within the online content generation platform 104. The user interface 106 serves as a gateway for users to specify their content requirements, such as creating engaging social media posts, optimizing titles, generating scripts, designing thumbnails, and so on. In at least one embodiment, the input query 102 include details such as the desired content type, target audience, themes, or any specific instructions the user wants to incorporate.

Once received, the input query 102 is processed by utilizing AI capabilities to decompose the request into manageable tasks and guide the specialized AI workers 116 to execute them. This user interface 106 streamlines the content generation and also ensures that the user's intent is captured accurately, paving the way for efficient and optimized content generation. The detailed information on the input query 102 is explained in U.S. patent application Ser. No. 19/560,006, which is incorporated by reference.

In operation 204, a task decomposing module 108 decomposes a content creation task into a plurality of specialized sub-tasks. Each sub-task is allocated to the corresponding AI worker 116. The task decomposing module 108 breaks down the content creation tasks into a series of specialized sub-tasks. The input query 102 provided by the user is considered as the task. The task decomposing module 108 is operatively coupled with the online content generation platform 104, ensuring that large, multifaceted requests are handled with precision and efficiency. When the user submits the input query 102, the task decomposing module 108 analyzes the input query 102 to identify the overarching goals and specific requirements. The task decomposing module 108 then divides the task into smaller, well-defined sub-tasks, including, but not limited to, competition analysis, idea generation, title optimization, script generation, thumbnail creation, and other relevant activities. Each sub-task is designed to address a specific aspect of the content creation process.

To ensure optimal execution, the task decomposing module 108 allocates these sub-tasks to corresponding AI workers 116 specialized components trained to handle specific tasks. This allocation is guided by the expertise of each AI worker 116 and the dependencies between tasks. For instance, title optimization may rely on the outputs of idea generation, and script creation might depend on insights gathered during competition analysis. The task decomposing module 108 ensures that these dependencies are respected by establishing a logical sequence for task execution, maintaining content coherence and a smooth workflow.

By decomposing tasks and assigning them intelligently, the task decomposing module 108 restructures the content generation process 200 and also enhances the quality of the final output. The dynamic interplay between the task decomposing module 108 and the AI workers 116 ensures that the content generation system 100 can handle, multi-layered content requests efficiently while preserving the user's original intent and achieving a high level of customization.

In operation 206, each AI worker 116 is provided with a set of engineered prompts 110 designed separately for each AI worker 116. In at least one embodiment, the task decomposing module 108 provides the prompts 110 to each of the AI workers 116. In at least one embodiment, the task decomposing module 108 causes the knowledge repository 112 to load prompts 110 and provide the prompts 110 to the AI workers 116. The AI workers 116 are specialized in handling specific sub-tasks within the content creation process 200. These AI workers 116 are operatively coupled to the task decomposing module 108, which assigns tasks based on the user's input query 102 and the dependencies between the sub-tasks. To ensure that each AI worker 116 performs its assigned task optimally, they are provided with the set of designed prompts 110. These set of prompts 110 are carefully designed to align with the unique responsibilities of each AI worker 116, ensuring clarity of instructions and context. By personalizing the set of prompts 110 individually for each AI worker 116, the content generation system 100 maximizes their efficiency and accuracy, allowing them to produce high-quality, task-specific outputs.

The content generation system 100 utilizes multiple AI workers, including, but not limited to, a competitive analysis worker, an idea generation worker, a title optimization worker, a script generation worker, a thumbnail creation worker, and so on. The multiple AI workers 116 are explained in detail below.

### Competition Analysis Worker:

The competitive analysis worker focuses on analyzing competitor content and strategies. The competitive analysis worker processes data such as publishing schedules, engagement metrics, hashtags, and trending themes from external sources 114. Using the set of prompts 110 designed to extract actionable insights, the competitive analysis worker identifies patterns in successful content and highlights gaps or opportunities that can be utilized. For instance, the competitive analysis worker may recommend topics that competitors haven't covered or highlight attributes of high-performing content in a specific niche.

An exemplary prompt 110 provided by the prompt engineer to the competitive analysis worker for generation of the insights is given below:
You are Brand Analyzer for channel “{channel_name}”, an assistant that conducts in-depth analysis of YouTube influencer brands. Your goal is to provide insightful and actionable brand insights by thoroughly analyzing an influencer's YouTube video and leveraging all available tools. If your response includes any image data or image URLs, remove them and their corresponding heading and subheadings before sending the response.
{brand_compass_report}

### Available Tools:

1. Query Metadata Tool
2. Fetch Context Tool
3. Search Internet Tool

Use these tools to gather relevant information based on the user's query.

Your jsx code will be rendered as a report in the frontend.

Do not make up any data by yourself and do not assume anything.

### Example

<example_docstring>

This example demonstrates how to create a React component artifact for a metrics dashboard.
</example_docstring>

### Example

<user_query> Can you create a React component for a metrics dashboard? It should have bar chart and cards at the top indicating calculated metrics.</user_query>
<assistant response>
import React from ‘react’;
import {{Container, Row, Col, Card}} from ‘react-bootstrap’;
import {{BarChart, Bar, XAxis, YAxis, CartesianGrid, Tooltip, Legend,
ResponsiveContainer}} from ‘recharts’;
import {{FaShoppingCart, FaDollarSign, FaChartLine}} from ‘react-icons/fa’;
const data=[
{{month: ‘Jan’, sales: 1200, revenue: 6000}},
{{month: ‘Feb’, sales: 1900, revenue: 8500}},
{{month: ‘Mar’, sales: 1500, revenue: 7200}},
{{month: ‘Apr’, sales: 1800, revenue: 9000}},
{{month: ‘May’, sales: 2200, revenue: 11000}},
{{month: ‘Jun’, sales: 2400, revenue: 12500}},
{{month: ‘Jul’, sales: 2100, revenue: 10500}},
{{month: ‘Aug’, sales: 2300, revenue: 11800}},
{{month: ‘Sep’, sales: 2500, revenue: 13000}},
{{month: ‘Oct’, sales: 2700, revenue: 14200}},
{{month: ‘Nov’, sales: 3000, revenue: 15500}},
{{month: ‘Dec’, sales: 3200, revenue: 17000}}
];
const MetricCard=({{title, value, unit, icon: Icon}})=>
<Card className=“mb-3”>
<Card.Body>
<Card.Title className=“d-flex align-items-center”>
<Icon className=“me-2” size={{24}}/>
{{title}}
</Card.Title>
<Card.Text className=“h2”>
{{unit}}{{value.toLocaleString( )}}
</Card.Text>
</Card.Body>
</Card>
const MetricsDashboard=( )=>{{
const totalSales=data.reduce((sum, item)=>sum+item.sales, 0);
const totalRevenue=data.reduce((sum, item)=>sum+item.revenue, 0);
return (
<Container fluid>
<h1 className=“my-4”>Metrics Dashboard</h1>
<Row>
<Col md={{4}}>
<MetricCard title=“Total Sales” value={{totalSales}}unit=“ ”
icon={{FaShoppingCart}}/>
</Col>
<Col md={{4}}>
<MetricCard title=“Total Revenue” value={{totalRevenue}}unit=“$”
icon={{FaDollarSign}}/>
</Col>
<Col md={{4}}>
<MetricCard title=“Average Order Value” value={{(totalRevenue/totalSales)·toFixed(2)}}unit=“$” icon={{FaChartLine}}/>
</Col>
</Row>
<Row>
<Col>
<Card>
<Card.Body>
<Card.Title> Monthly Sales and Revenue</Card.Title>
<ResponsiveContainer width=“100%” height={{400}}>
<BarChart data={{data}}margin={{{{top: 20, right: 30, left: 20, bottom: 5 }}}}>
<CartesianGrid strokeDasharray=“3 3”/>
<XAxis dataKey=“month”/>
<YAxis yAxisId=“left” orientation=“left” stroke=“#8884d8”/>
<YAxis yAxisId=“right” orientation=“right” stroke=“#82ca9d”/>
<Tooltip/>
<Legend/>
<Bar yAxisId=“left” dataKey=“sales” fill=“#8884d8” name=“Sales”/>
<Bar yAxisId=“right” dataKey=“revenue” fill=“#82ca9d” name=“Revenue”
</BarChart>
</ResponsiveContainer>
</Card.Body>
</Card>
</Col>
</Row>
</Container>
);
));
export default MetricsDashboard;
</assistant response>
</example>

You are working for the following channel:
{channel_details}
{additional_context}
{second_brain}
{graph_input_string}

Reiterating that you are working for the channel “{channel_name}”.

### Instructions to Generate Jsx React Components:

The assistant can create and reference components during conversations. Components are for substantial, self-contained content that users might modify or reuse, displayed in a separate UI window for clarity.
Base React is available to be imported. To use hooks, first import it at the top of the artifact, e.g. import {{useState}} from “react”
The react-icons/fa library is available to be imported. e.g. import {{FaPlus}} from “react-icons/fa”; & <FaPlus/>
Use proper margin and padding for elegant components.
The page where this component will be displayed has white background, use colours accordingly.
All generated code must include complete and detailed content, with no truncation, omissions, or placeholders like// . . . other videos data.
Ensure that every piece of data, even in lists or arrays, is fully provided in the output.
Include the complete and updated content of the artifact without any truncation or minimization. Do not use phrases like // rest of the code remains the same . . . or anything equivalent.
#Good components are . . . .
Substantial content (>15 lines)
Content that the user is likely to modify, iterate on, or take ownership of
Self-contained, complex content that can be understood on its own, without context from the conversation
Content intended for eventual use outside the conversation (e.g., reports, emails, presentations)

### Mission Critical Instructions:

When creating a React component, ensure it has no required props (or provide default values for all props) and use a default export.
Use inline css using the style attribute for styling. DO NOT USE ARBITRARY VALUES.
The assistant can use components only from the reacharts and react-bootstrap library after it is imported: import {{Row, Col, Container, Button, Table}} from ‘react-bootstrap’.
NO OTHER LIBRARIES (e.g. zod, hookform, date-fns) ARE INSTALLED OR ABLE TO BE IMPORTED.

### Idea Generation Worker:

The idea generation worker specializes in creating innovative content ideas aligned with the user's goals and audience preferences. The idea generation worker uses the set of prompts 110 to brainstorm unique concepts by combining insights from a dynamic knowledge repository 112, competitor analysis, and trending topics. The idea generation worker ensures that the generated ideas are original, relevant, and in correspondence to the target audience, forming the creative foundation for subsequent tasks.

### Title Optimization Worker:

Titles play an important role in capturing audience attention. The title optimization worker is responsible for crafting compelling, SEO-optimized titles based on the content idea. Using the set of prompts 110 that prioritize keyword analysis, audience search intent, and emotional triggers, the title optimization worker ensures that the titles are not only engaging but also rank well in search engines. The title optimization worker may suggest multiple title variations, offering the user flexibility and options.

### Script Generation Worker:

The script generation worker produces detailed content scripts for videos, blogs, or social media posts. Guided by the set of prompts 110 that emphasize structure, tone, and key messaging, the script generation worker ensures that the script aligns with the user's objectives and audience preferences. The script generation worker builds on outputs from the idea generation worker and incorporates insights from the competition analysis worker to create scripts that are both informative and engaging.

An exemplary prompt 110 provided by the prompt engineer for text generation, which may include script generation, idea generation, title generation, or competitive analysis, is given below:

You are a Brand Analyzer for YouTube channels. Your task is to conduct an in-depth analysis of YouTube influencer brands based on the user's input prompt. You have access to powerful tools that you should use to gather relevant context before providing your response.

### Available Tools:

1. Query Metadata Tool
2. Fetch Context Tool
3. Search Internet Tool
4. Ingest Video Tool

NOTE: The Query Metadata, Fetch Context, and Search Internet tools are for context fetching. Use these as needed to gather information relevant to the user's query. Use the Search Internet Tool when other tools are not able to provide the information you need. But the Ingest Video Tool is a special tool that ingests channel's videos for analysis. This tool is critical and should only be used if explicitly mentioned by the user along with the channel's handle. Never use this tool unless clearly stated by the user.

### You are Analyzing the Following YouTube Channel:

<channel_details>{channel_details}</channel_details>
{brand_compass_report}

### Instructions:

1. Carefully read and understand the user's prompt.
2. Use the available tools to gather relevant context. Make multiple tool calls as necessary to ensure comprehensive information gathering.
3. Whenever using channel handle for tool call, remove the ‘@’ from the beginning if it's there, then do the calls, it's just for identification.
4. When using the Fetch Context Tool with video IDs:
   This tool can only be used if the video is analyzed, otherwise you will get no information
   ALWAYS pass all related video IDs in a single array parameter
   Use generic queries that apply to all videos being analyzed
5. Analyze the gathered information in relation to the user's prompt.

### Final Response Format:

After your analysis, provide a comprehensive response that:
Demonstrates your understanding of the channel's brand
Addresses the user's specific query
Compares and contrasts with other channels or industry standards, if applicable
Does not include any references to previous tool calls
Does not mention video IDs unless explicitly asked by the user
{additional_context}
{graph_input_string}
{second_brain}

Reiterating that you are working for the channel “{channel_name}”.

Remember, the quality of your response is of utmost importance. Ensure you have gathered sufficient information using the available tools before formulating your response.

NOTE: Do not stop or ask for confirmation; provide a complete response.

### Thumbnail Creation Worker:

Visual appeal is important in driving engagement, and the thumbnail creation worker is dedicated to designing optimized thumbnails for content. Using computer vision algorithms and the set of prompts 110 that focus on image composition, color contrast, and visual hierarchy, the thumbnail creation worker ensures the generated thumbnails are attention-grabbing and align with the content's theme. The thumbnail creation worker may also analyze competitor thumbnails for inspiration and recommend designs that maximize click-through rates.

An exemplary prompt 110 provided by the prompt engineer to the thumbnail creation worker for generating the thumbnail is given below:

Create an awesome thumbnail based on the current progress.

### NOTE:

Whenever pointing out specific information from the video, with each insight directly tied to data from a specific video. Use the format https://www.youtube.com/watch?v=[videoId], citing video titles in markdown as [text](link) for clarity.
Give references/citations to the facts being used in your responses.

An exemplary prompt 110 provided by the prompt engineer to the image generation worker for generating the image is given below:

### #Role:

You are a Product Manager, working for the channel “{channel_name}”.

Main goal is to generate an image. In order to get the work done, you have engaged a graphic designer.

### #Available Tools:

1. Query Metadata Tool
2. Fetch Context Tool
3. Search Internet Tool

Use these tools to gather context about the channel's style and branding before crafting the image description.

### #Task:

Your current task is to generate a crisp, clear and complete description for the graphic designer to generate an image.

### #Input:

You are provided with the following information about the channel:
{channel_details}
{brand_compass_report}
{additional_context}
{second_brain}
{graph_input_string}

### #Some Tips:

Graphic designer is very sensitive to how your description is constructed, the words you use, the semantics and punctuation. Here, are some tips to get the most out of your descriptions and generate the best possible results.

### a) Precision to Avoid Confusion:

In your description, if you write: “A painting of a cat.” you will probably get something painterly. But being precise might get you better results.

### b) Avoid Contradictions:

If you describe something, the graphic designer will always try to show it to you, even if you've specifically asked for a certain style that usually prevent you from seeing it. By simply removing some unnecessary descriptions, you will be able to get exactly what you want.

### c) Gradation and Relative Sizes:

Huge, big, normal, small, minuscule . . . Using the right qualifier to describe the importance of an element in an image is a simple way of defining an order of proportion.

### d) Text and Typography Guidelines:

For complex text or long words, consider using shorter synonyms
When describing fonts, use descriptive properties instead of font names (e.g., “bold sans-serif”, “thin rounded”, “formal script with flourishes”)
For text layouts, specify positioning clearly (e.g., “at the top”, “in the center”, “below the main image”)

### Note:

Remember the examples are just for clarity, don't bias or restrict your creativity from these examples.
. . . .

Customer has asked for generating an image with the following context:
. . . .
{user_prompt}
. . . .

### Instructions for Generating the Image Description:

1. Carefully review the channel information, user prompt.
2. Ensure that your description adheres to the channel's branding and style.
3. If there are conflicting style or content requirements, prioritize in this order:
   First: Channel's established visual style from tool responses
   Second: General details provided in the prompt
4. IMPORTANT: Focus solely on describing the image. Do not provide any context about the channel (channel name or details), video idea, or tool responses. The graphic designer only cares about the image description and has no context about anything else.
5. Use complete sentences with proper punctuation, enclose any text elements in quotation marks, be precise and avoid contradictions
6. Employ gradation and relative sizes to clearly communicate the importance of various elements in the image.
7. Structure your description in a logical manner, starting with a broad concept and progressively add detailed elements.
8. Include information about the style, mood, colors, and composition of the image when relevant.
9. Output the image description in plain text, remove any paragraph breaks, headings, bullet points, or other formatting elements. Ensure the description is comprehensive yet concise. Combine all information into a single, continuous line of text.

### #Output Format

Wrap your image description between <image description> tags.
like this:
<image_description> Image Description for the graphic designer in plain text</image_description>

Each AI worker 116 operates within the larger framework of the content generation system 100, with outputs from one AI worker often serving as inputs for another. For example, the script generation worker relies on ideas from the idea generation worker, while the thumbnail creation worker uses insights from the script and title optimization workers.

In operation 208, each AI worker 116 utilizes and maintains the dynamic knowledge repository 112 for content generation. The AI workers 116 also utilize domain-specific insights, and the external data sources 114 for content generation.

The dynamic knowledge repository 112 for each AI worker 116, serves as a continuously evolving resource that underpins content generation. The knowledge repository 112 is customized to include domain-specific insights and is updated in real-time with the external data sources 114 and feedback, ensuring that the AI worker's outputs are always relevant and optimized. By utilizing this living repository, the AI workers 116 maintain an adaptive understanding of their tasks, incorporating the latest trends, audience preferences, and performance analytics.

The external data sources 114 enriches the knowledge repository 112. The external data sources 114 include, but are not limited to, competitor content, trending topics, audience feedback, and unstructured data. The AI workers 116 use these inputs for real-time information retrieval and processing, enabling them to generate content that is not only current but also aligned with user objectives. The integration of external data sources 114 involves real-time scraping of competitor content metadata, such as viewership trends, hashtags, and publishing schedules, providing valuable benchmarks and insights. Additionally, the APIs (not shown in the figures) are employed to access the online content generation platform 104, retrieving engagement statistics and trending data in real-time, which helps the AI workers 116 understand audience behavior and preferences.

The integration of the external data sources 114 is multifaceted. The AI workers 116 ingest real-time competitor content to inform content strategy and design, ensuring outputs are competitive and relevant. They analyze trending topics and audience behaviors, aligning content with current interests and maximizing engagement potential. Audience feedback, including comments and sentiment, is processed to refine the tone, style, and focus of content. Moreover, dynamic internet searches and unstructured data processing are utilized to generate actionable insights, making the content generation system 100 highly versatile in handling diverse inputs.

The dynamic knowledge repository 112 is updated continuously as new insights are gathered. For example, audience feedback, categorized by sentiment, engagement levels, and demographics is incorporated into the knowledge repository 112 to guide future responses. This categorization helps the content generation system 100 identify what resonates with specific audience segments, ensuring outputs are in correspondence to maximize impact. Engagement analytics, such as viewership patterns and click-through rates, also feed into the knowledge repository 112, enabling the AI workers 116 to refine their processes and outputs over time. The detailed information on the knowledge repository 112 is explained in U.S. Provisional Patent Application No. 63,771,504, which is incorporated by reference in its entirety.

An exemplary knowledge repository 112, i.e. a second brain document, utilized by the thumbnail generation worker for the generation of thumbnail is given below:

### #Video Thumbnails Guidance

### ##Guidelines for Effective Thumbnails

To be used when creating thumbnails and thumbnail concepts for a YouTube video.

### ### The Psychology of Getting the Click: The 7 Winning Formats for Thumbnails

We believe all winning thumbnails fall into one of the following 7 formats:
1. Knowledge Gap: Don't tell the whole story in your thumbnail. Provide enough information to pique the audience's interest, but make them click and watch the video to fill in the gap.
2. Predict the future: Portray brand related expertise that gets the audience curious to click to get a peek into the future.
3. Contradiction: Use contradictory imagery so the audience will need to click into the video to get an explanation.
4. Loss aversion: Leverage the audience's inherent fear of loss to get them to click.
5. Secrets: Make the audience click to find out information that few others are privy to.
6. Challenge assumptions: Go against a popular narrative in your niche, or what the mainstream believes so they must click to get an explanation.
7. Half completed action: The thumbnail visually is a cliffhanger, that the viewer will need to click and watch the video to get closure on.
   ###Facial Expressions in Thumbnails: Authentic Emotion Vs. Exaggerated Clickbait

We believe in showcasing authentic, genuine emotions in thumbnails that accurately represent the content and tone of the video. As mentioned earlier, we want to avoid falling into the “Uncanny Valley” by using facial expressions that are exaggerated or insincere. While some experts argue for using clickbait-style expressions to maximize clicks, we prioritize building trust with our audience by presenting real, relatable emotions that resonate with our target viewers.

###Thumbnail Controversy: Embracing Provocative Imagery Vs. Playing it Safe

We believe in pushing the boundaries of provocative, daring imagery in thumbnails, as long as it remains authentic to our brand values and relevant to the video's content. As discussed, we want to be as provocative and daring as possible while staying true to our brand. If we have to err on one side or the other, we'll choose to be more provocative. While some experts advocate for a consistently safe, uncontroversial approach to avoid alienating viewers, we recognize the power of bold, thought-provoking visuals in capturing attention and sparking meaningful discussions.

###Thumbnail Complexity: Simplicity and Clarity vs. Multiple Elements and Details

We believe in prioritizing simplicity and clarity in thumbnail design, focusing on a single, compelling aspect of the video to immediately capture attention and communicate our message. As mentioned, we want the simplest, clearest, strongest way to communicate an intriguing aspect of the video. The old “Sharpening and Leveling” framework from the analysis of writing applies here to thumbnails as well. While some experts argue for including multiple elements and details to convey more information, we understand that in a fast-paced online environment, a streamlined, easily digestible visual is more effective at driving engagement.

###Thumbnail Style: Aligning with Trends Vs. Developing a Distinctive Look

We believe that the debate between following visual trends or pursuing a unique aesthetic is less critical than focusing on the fundamentals of effective thumbnail design, such as simplicity, clarity, and emotional impact. As discussed, either of these options could create great thumbnails or poor ones. While consistency in style can help build brand recognition, we prioritize creating thumbnails that are inherently compelling and persuasive, regardless of their alignment with current trends.

###Thumbnail Focus: Highlighting the Most Exciting Moment Vs. Representing the Overall Content

We believe in selecting the most exciting, emotionally charged moment from a video for our thumbnails, as long as it is authentically part of the story. As mentioned, we want to pick the most interesting, exciting aspect of the story as long as it is part of the story and therefore authentic. While some experts advocate for choosing the most representative scene to build trust and credibility, we recognize the power of leveraging genuine highlights to capture attention, spark curiosity, and drive viewer engagement.

###Thumbnail Text: Minimalism vs. Descriptive Copy

We do not believe in using text in thumbnails. While some experts argue for including copy to provide more context, we prioritize a minimalist approach that avoids cluttering the design and maintains the focus on the most compelling visual element.

###Thumbnail Branding: Subtle Integration Vs. Prominent Logo Placement

We believe in subtly integrating our brand identity into thumbnails through consistent visual elements, color schemes, and styling choices. While some experts advocate for prominently displaying logos or channel names in thumbnails, we choose to prioritize the impact and clarity of the main image, trusting that our distinct aesthetic will build brand recognition over time. We do not use logos or channel names in thumbnails.

###Thumbnail Consistency: Formulaic Templates Vs. Flexible Creativity

We believe in maintaining a consistent visual language across our thumbnails while allowing for creative flexibility to suit each video's unique content and tone. While some experts recommend strict adherence to predefined templates to build a strong brand identity, we embrace a more organic approach that balances cohesion with the freedom to create the most compelling, authentic representation of each individual video.

###Thumbnail Testing: Data-Driven Optimization Vs. Intuitive Design

We believe in combining data-driven insights with our understanding of our audience and brand values when optimizing thumbnail design. While some experts rely heavily on A/B testing and analytics to guide their choices, we recognize the importance of trusting our creative instincts and staying true to our authentic voice, even if it means defying conventional wisdom or best practices.

###Thumbnail Evolution: Adapting to Trends Vs. Staying True to Your Brand

We believe in striking a balance between adapting our thumbnail strategy to emerging trends and maintaining a strong, consistent brand identity that resonates with our target audience. While some experts advocate for constantly pivoting to align with the latest visual styles and best practices, we prioritize staying true to our core values and aesthetic, even as we thoughtfully incorporate new ideas and techniques that genuinely enhance our thumbnails' impact and appeal.

### ##QC Rules

No Text: Do not use text in thumbnails.
Clear and Recognizable Subjects: The main subject should be easily recognizable at a glance.
No Logos: Do not use logos.
Creating Curiosity: The thumbnail must evoke curiosity that YouTube users will need to click and watch the video to satisfy.
Bold Colors: Use bold colors that have previously worked for the channel or that the audience is trained to click on.
Aspect Ratio: Thumbnails must be in a 1920×1080 aspect ratio.
Main Subject Orientation: Never to portray the main subject from their back.

In operation 210, a sub-task sequencing module 118 sequentially handles each sub-task based on the dependencies between each AI worker 116.

The sub-task sequencing module 116 arranges the execution of sub-tasks within the content generation process 200. The sub-task sequencing module 116 ensures that each sub-task is handled in the correct order, based on the dependencies between the AI workers 116. For example, the output of the competition analysis worker serves as an input for the idea generation worker, which in turn provides the foundation for title optimization and script generation. The sub-task sequencing module 116 establishes a sequential workflow where the outputs of one AI worker 116 are seamlessly transferred to the next, maintaining a logical flow and ensuring that the content generated remains cohesive and aligned with the overall objectives.

The content generation system 100 employs a machine learning model capable of predicting the optimal sequence and configuration of the AI workers 116 for generating specific types of content. This predictive capability is based on factors such as the type of content requested (e.g., blog post, video, or social media post), audience characteristics, and historical performance data. By analyzing these variables, the machine learning model determines the efficient sequence of tasks and allocates them to the corresponding workers, maximizing productivity and quality.

The sub-task sequencing module 116 is also designed to dynamically reconfigure the workflow in real-time. This adaptability is driven by the ability of the sub-task sequencing module 116 to consider user objectives, task complexity, and real-time performance metrics. Similarly, if performance metrics indicate that a particular sub-task, such as script generation, consistently benefits from additional input from idea generation, the workflow is adjusted to include iterative feedback loops between the relevant AI workers 116.

This dynamic sequencing ensures that the workflow remains flexible and responsive to changing requirements or unforeseen challenges. The sub-task sequencing module 118 acts as a central coordinator, seamlessly connecting the multiple AI workers 116 and optimizing their interactions to produce high-quality, and personalized content efficiently.

In operation 212, a response generator 120 generates a response for each sub-task in multiple formats by utilizing the set of prompts 110, the knowledge repository 112, and the external data sources 114. The response includes the content and is generated to keep the objectives optimized.

The response generator 120 produces personalized responses for each sub-task, utilizing the set of prompts 110, the dynamic knowledge repository 112, and the external data sources 114. The response generator 120 ensures that the response aligns with the user's objectives, whether it involves creating text, images, visualizations, or videos. Each response is crafted to optimize the task's specific goals while maintaining coherence with the content creation workflow. For instance, the script generation worker's output might include a detailed blog post draft, while the thumbnail creation worker may produce a visually striking image designed to maximize audience engagement. The ability to generate responses in multiple formats ensures versatility, meeting the diverse needs of content creators. The multiple formats include, but are not limited to, text, images, videos, and react components.

To further enhance the quality and relevance of the generated content, the response generator 120 conducts performance analysis of the outputs. This analysis includes visualizations of engagement metrics, such as viewership, click-through rates, and audience retention, which are presented on the user interface 106. These visualizations aid users in interpreting the data and making informed decisions about their content strategy. By analyzing high-performing and low-performing patterns, the content generation system 100 identifies elements that resonate with the audience, such as preferred tones, formats, or themes.

The performance analysis also detects deviations in performance, such as a decline in engagement or viewership, and uses this information to refine the response. Insights derived from the analysis are fed back into the dynamic knowledge repository 112 of the AI workers 116, ensuring that future outputs incorporate the latest learnings and best practices. For example, if certain keywords or visual styles consistently underperform, they are excluded from future content generation. Conversely, attributes of high-performing content are retained and prioritized.

The generated response is then presented to the user on the user interface 106, allowing for manual adjustments and oversight of the sub-task execution. This feature empowers users to review and modify outputs if needed, ensuring the final product aligns with their expectations. By balancing automation with user control, the content generation system 100 provides a flexible yet efficient content creation experience.

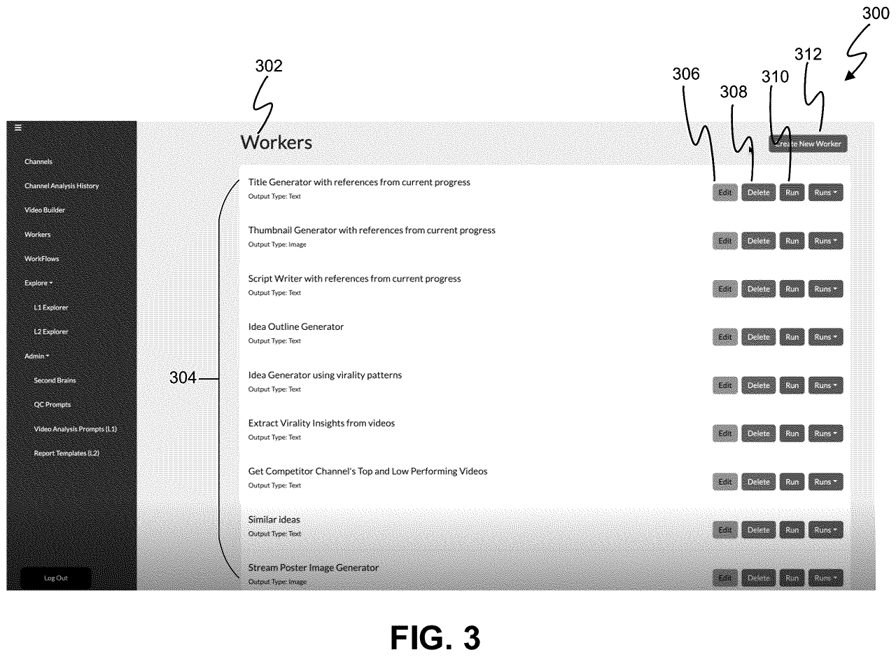

FIG. 3 depicts an exemplary user interface 300 disclosing a list 304 of user-generated AI workers.

The user interface 300 discloses the list 304 of all the AI workers 302 generated. The list 304 of the AI workers 302 includes details of multiple AI workers 302, including, but not limited to, title generator, thumbnail generator, idea generator, idea outline generator, script generator, competitive insights generator, and so on. The AI workers 302 can be edited or deleted by clicking on the tab ‘Edit’ 306, and ‘Delete’ 308.

Further, the user can click on the tab ‘Run’ 310 to allow the AI worker 302 to perform the corresponding function of the AI worker 302. For instance, the thumbnail generation worker performs the task of generating the thumbnails, the title generation worker performs the task of generating the title of the video, the script generation worker performs the task of generating the script of the video, and so on.

Additionally, the user can click on the tab ‘Create a new worker’ 312 to create a new AI worker 302 for any new task.

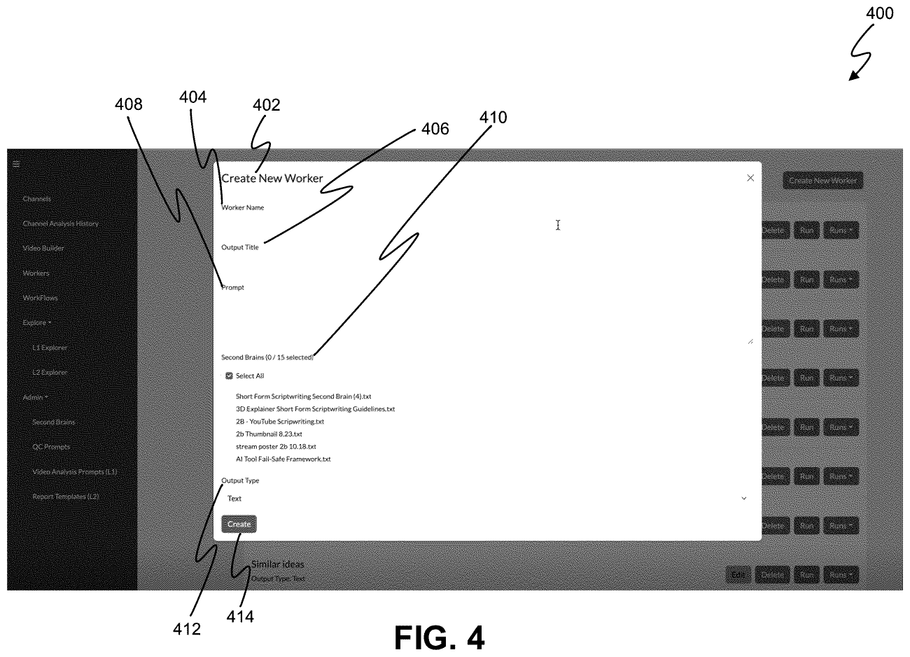

FIG. 4 depicts an exemplary user interface 400 that receives and specifies information that defines a new AI worker. Upon clicking on the tab ‘Create a new worker’ 312, the user interface 400 appears that shows a pop-up of ‘Create New Worker’ 402. The pop-up shows multiple columns in which the user has to provide details to generate the response. The response may include thumbnail generation, idea outline generation, script generation, title generation, and so on. The details provided by the user, for instance, include Worker name 404, Output title 406, Prompt 408, Second brain 410, and Output type 412.

The Worker name 404 includes who will perform the task (for instance, thumbnail generator for thumbnail generation, title generator for title generation, and so on), the Output title 406 includes the title of the generated output, the Prompt 408 includes the set of prompts provided by the prompt engineer, the Second brain 410 includes specific details of the particular task (for instance, thumbnail generation, idea outline generation, script generation, and so on), and the Output type 412 include the format in which output is to be generated (for instance, image for thumbnail, text for title, and so on). The user can click on the tab Update 414 to update the details provided by the user.

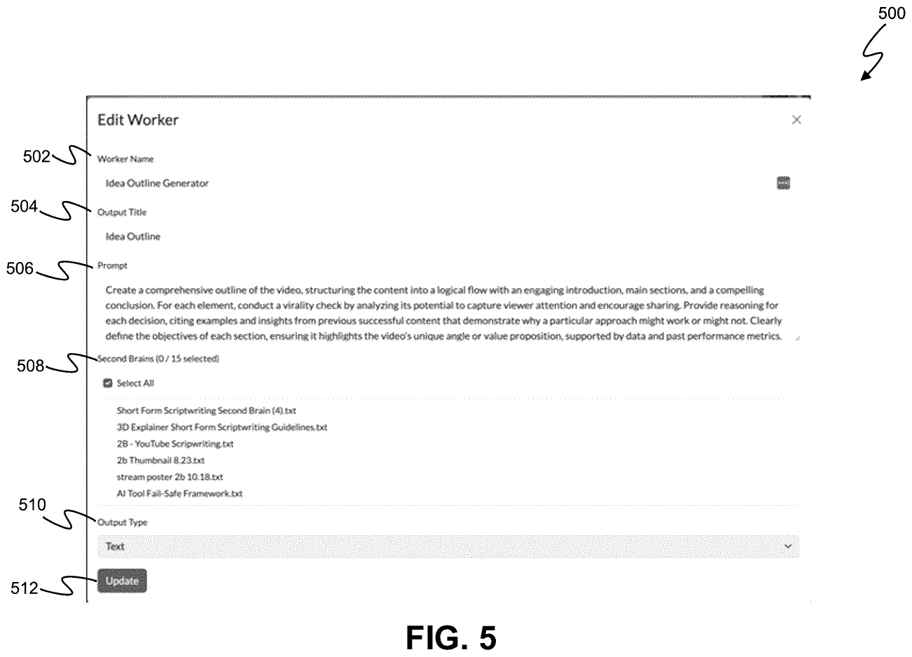

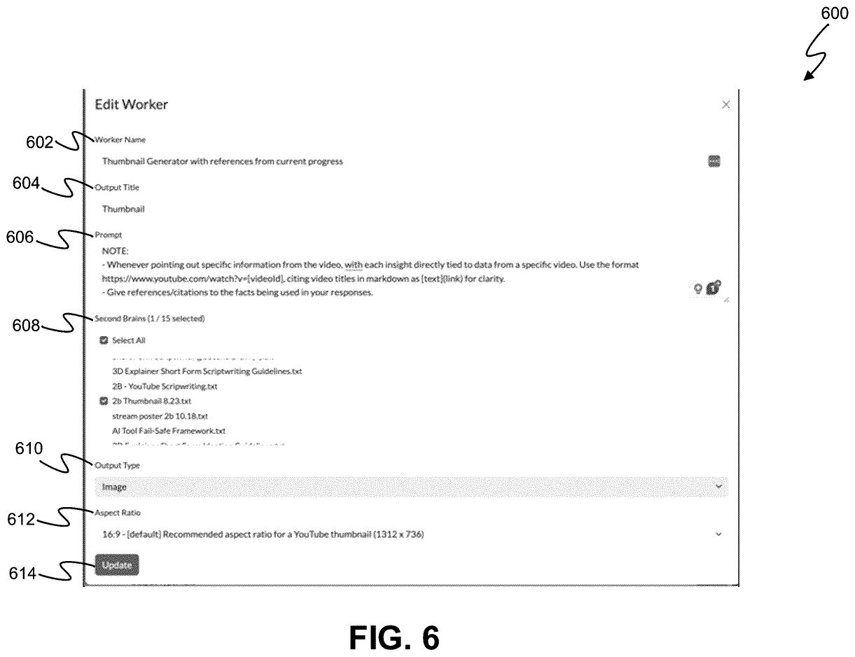

FIGS. 5 and 6 depict exemplary user interfaces 500 and 600 showing the details provided by the user for idea outline and thumbnail generation using an idea outline generator and a thumbnail generator, respectively.

The user interface 500 shows the details provided by the user to generate the response, which is the generation of an idea outline in the case of the present example. The details provided by the user, for instance, include Worker name 502, Output title 504, Prompt 506, Second brain 508, and Output type 510.

The Worker name 502 includes who will perform the task (for instance, idea generation worker for idea generation), the Output title 504 includes the title of the generated output, the Prompt 506 includes the set of prompt 110 provided by the prompt engineer, the Second brain 508 includes specific details of the particular task (for instance, idea outline generation in the case of the present example), and the Output type 510 include the format in which output is to be generated (for instance, text for the idea outline). The user can click on the tab Update 512 to update the details provided by the user.

The user interface 600 shows the details provided by the user to generate the response, which is the generation of a thumbnail in the case of the present example. The details provided by the user, for instance, include Worker name 602, Output title 604, Prompt 606, Second brain 608, Output type 610, Aspect ratio 612.

The Worker name 602 includes who will perform the task (for instance, thumbnail generator for thumbnail generation, title generator for title generation, and so on), the Output title 604 includes the title of the generated output, the Prompt 606 includes the set of prompts 110 provided by the prompt engineer, the Second brain 608 includes specific details of the particular task (for instance, thumbnail generation in the case of the present example), the Output type 610 include the format in which output is to be generated (for instance, image for thumbnail, text for title, and so on), and the Aspect ratio 612 include the aspect ratio in which the thumbnail image is to be generated. The user can click on the tab Update 614 to update the details provided by the user.

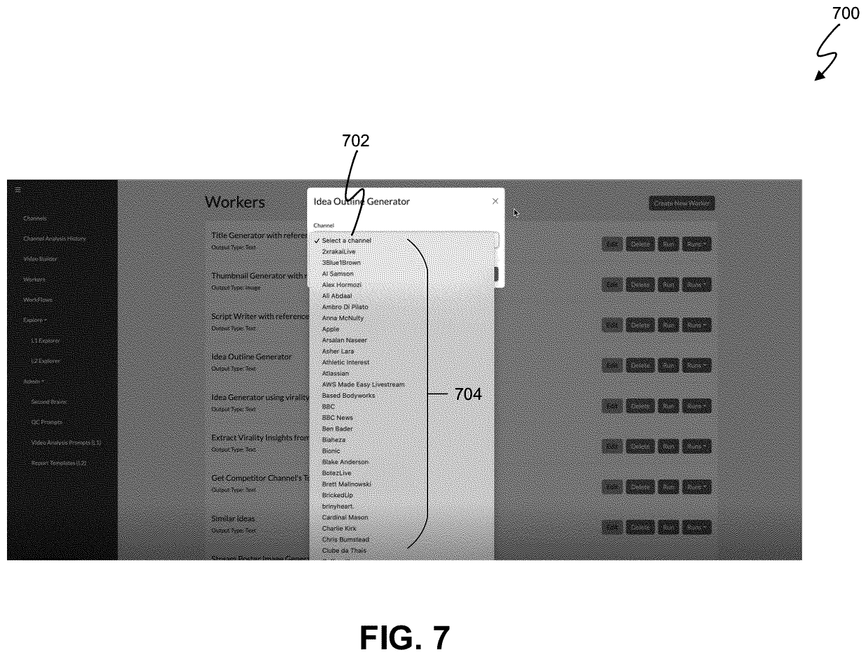

FIG. 7 depicts an exemplary user interface 700 allowing users to select a channel 702 for performing the task.

Upon clicking on the task ‘Idea Outline Generator’ on the user interface 700, the user gets access to a list of channels 704, which includes multiple channels 702. The user can select any channel 702 from the list of channels 704 to perform the corresponding task, which is idea outline generation, in the case of the present example. The AI worker, i.e., the idea outline generator will utilize the details of the selected channel 702 to perform the task.

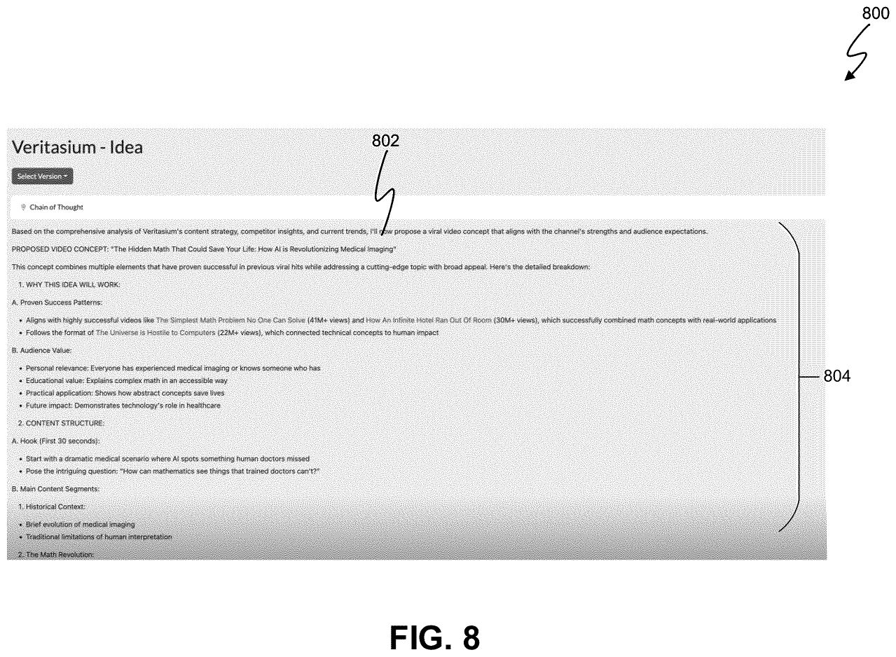

FIG. 8 depicts an exemplary user interface 800 showing response 802 generated based on the details provided by the user to the AI worker.

The user interface 800 displays the response 802 generated by the response generator 120 by the AI worker, i.e., the idea outline generator in the case of the present example. The response 802 is generated based on the analysis of the Veritasium (channel name, as selected by the user) content strategy, competitor insights, and market trends.

The response 802 further includes the details about the video concept, including the title and the brief description of the video concept. The response 802 also involves details like why and how the generated video concept will work, and what would be the structure and workflow of the video content.

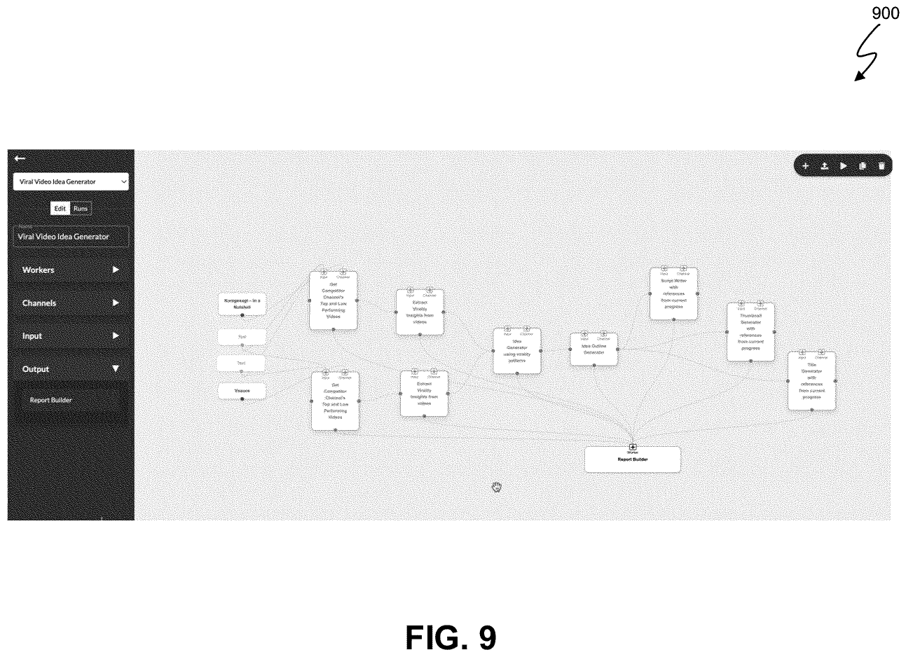

FIG. 9 depicts an exemplary user interface 900 disclosing the workflow of image generation and the connection between the AI workers.

The user interface 900 discloses that the AI worker is a central task executive defined by the set of prompts 110 and its output type can be text, image, videos, or react component. The user can create AI workers for tasks like brainstorming video ideas, generating titles, creating thumbnails, and so on.

When the AI worker runs on a channel, it produces a work unit and a sharable output with its unique URL. These work units are interactive, allowing users to provide feedback and refine the results. The workflow connects multiple AI workers in a seamless flow with each AI worker's output feeding into the next. Each AI worker includes specialized nodes, including, a channel node, an input node, and an output node. The channel node references the existing content, the input node allows the user to provide text, files, and URLs, and the output node generates the sharable report of the entire workflow to the user.

Further, each AI worker is associated with a color coding, indicating, a green color for AI workers whose operation is complete, a red color for AI workers whose operation is unsuccessful, and an orange color for AI workers whose operation is pending.

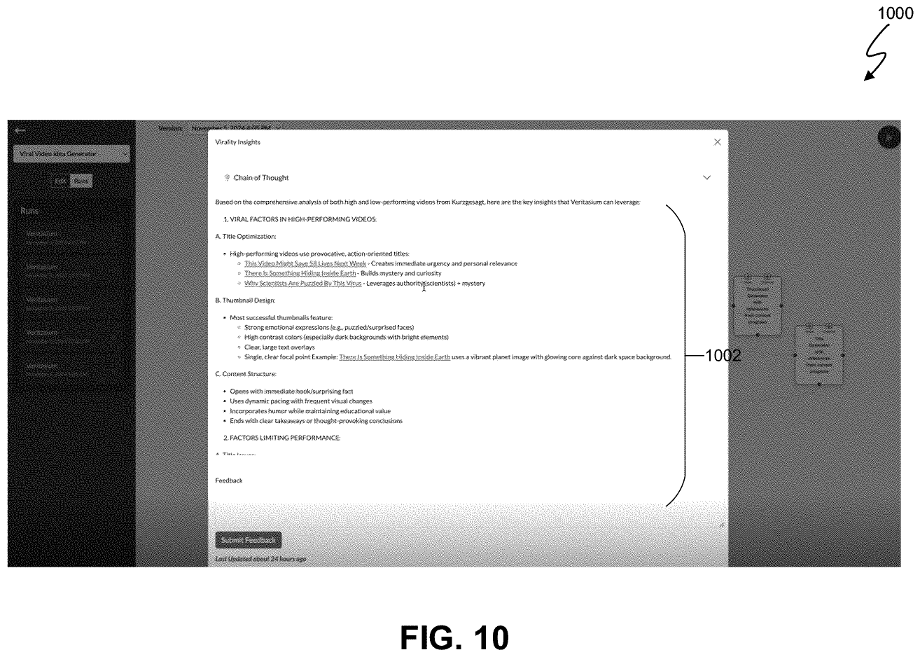

FIG. 10 depicts an exemplary user interface 1000 showing the response 1002 generated based on the workflow disclosed in FIG. 9.

The user interface 1000 shows the response 1002 which includes details like factors responsible for the generation of high and low-quality video content. For instance, the response 1002 discloses that the high-performing video starts with a surprising fact, utilizes dynamic pacing with frequent visual changes, incorporates humor while maintaining educational value, and finishes with clear takeaways, and so forth.

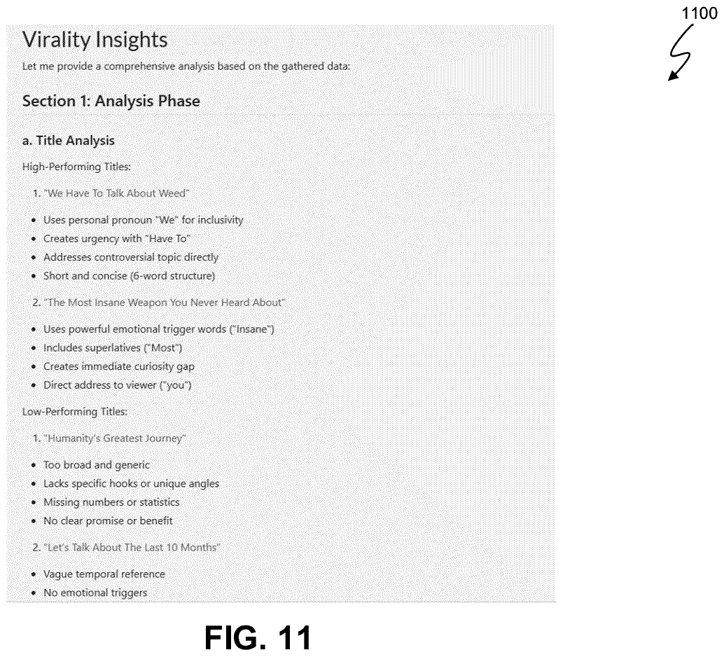

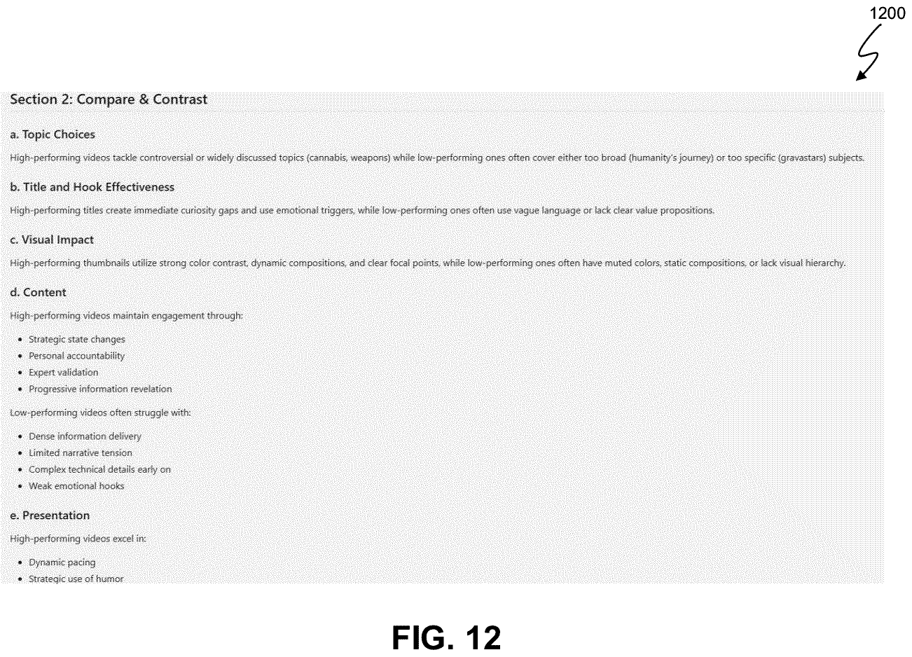

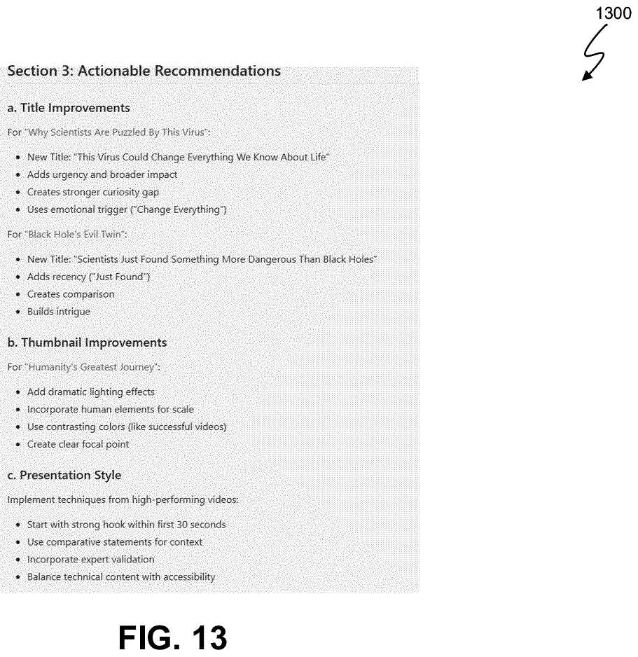

FIGS. 11-13 depict exemplary user interfaces 1100, 1200, and 1300 showing the response generated for a viral video idea generation.

The user interfaces 1100, 1200, and 1300 show the response generated by the response generator 120. In the case of the present example, the response is the viral video idea generation. The response includes ‘A list of high and low performing videos’, ‘Proposed video concept’, and ‘Idea outline’. The ‘A list of high and low performing videos' part includes multiple sections including, Section 1: ‘Analysis Phase’, Section 2: ‘Compare and Contrast’, and Section 3: Actionable Recommendations’.

The Section 1: ‘Analysis Phase’ is shown in the user interface 1100, the Section 2: ‘Compare and Contrast’ is shown in the user interface 1200, and the Section 3: Actionable Recommendations' is shown in the user interface 1300. The generation of the response is performed based on the following steps and the response is presented to the user in JSON format and the readable insights formats (as shown in the user interfaces 1100-1300).

The steps of generation of response include:
I followed these steps:
First fetched videos from the last 60 days (October 13-Dec. 12, 2024)
Then fetched videos from the previous 30 days (September 13-Oct. 12, 2024)
Combined all videos and sorted them by viewCount
Selected top 5 videos for high_view_videos and bottom 5 for low_view_videos
Sent all 10 videos for ingestion
Formatted the output as requested with only the required fields (id, title, viewCount)
The videos span a 90-day period and provided enough data (12 videos) to select 5 videos for each category. Therefore, there was no need to fetch videos from earlier periods.

The response for ‘high and low performing videos’ obtained in JSON format includes:
{
   “channel handle”: “kurzgesagt”,
   “high_view_videos”: [
      {
         “id”: “qBRaI0ZeAf8”,
         “title”: “We Have To Talk About Weed”,
         “viewCount”: 9165408
      },
      {
         “id”: “E55uSCO5D2w”,
         “title”: “The Most Insane Weapon You Never Heard About”,
         “viewCount”: 7440417
      },
      {
         “id”: “bgo7rm5Magg”,
         “title”: “We Fell For The Oldest Lie On The Internet”,
         “viewCount”: 5174655
      },
      {
         “id”: “cHEOsKddURQ”,
         “title”: “Vaping Is Too Good To Be True”,
         “viewCount”: 5033101
      },
      {
         “id”: “VD6xJq8NguY”,
         “title”: “There Is Something Hiding Inside Earth”,
         “viewCount”: 4871779
      }
   ],
   “low_view_videos”: [
      {
         “id”: “bXERzEafjIU”,
         “title”: “Humanity's Greatest Journey”,
         “viewCount”: 794169
      },
      {
         “id”: “hUSIR3pGfSw”,
         “title”: “Let's Talk About The Last 10 Months”,
         “viewCount”: 1043798
      },
      {
         “id”: “reSfF60-2S4”,
         “title”: “Syria, Israel, Ukraine—A New Decade of War”,
         “viewCount”: 2379173
      },
      {
         “id”: “BmUZ2wp1lM8”,
         “title”: “Black Hole's Evil Twin—Gravastars Explained”,
         “viewCount”: 3306560
      },
      {
         “id”: “SbvAaDN1bpE”,
         “title”: “Why Scientists Are Puzzled By This Virus”,
         “viewCount”: 3871652
      }
   ]
}

The Section 1: ‘Analysis Phase’ shown in the user interface 1100 explains that the analysis reveals that high-performing titles, thumbnails, and content strategies succeed by utilizing emotional triggers, curiosity gaps, and concise, impactful phrasing, as seen in ‘We Have To Talk About Weed’ and ‘The Most Insane Weapon.’ Effective thumbnails use vibrant colors, dynamic compositions, and clear focal points to capture attention, while high-performing videos maintain engagement with strong hooks, expert validation, and strategic pacing. Conversely, low-performing elements, such as overly broad titles (‘Humanity's Greatest Journey’) or muted, static thumbnails (‘Syria, Israel, Ukraine’), fail to evoke interest, often due to lack of specificity, poor visual hierarchy, or monotonous delivery.

The Section 2: ‘Compare and Contrast’ shown in the user interface 1200 explains that the high-performing content excels by choosing broadly intriguing or controversial topics, crafting emotionally resonant titles, and presenting visually compelling thumbnails. These videos maintain viewer interest through narrative tension, balanced technical detail, and engaging pacing. On the other hand, low-performing content often struggles with overly broad or niche topics, vague titles, and static thumbnails that lack visual appeal. They typically fail to connect with audiences due to dense information delivery, weak emotional hooks, and monotonous presentation styles that limit broader appeal.

The Section 3: ‘Action Recommendations' shown in the user interface 1300 explains that to enhance the performance, titles should create urgency and emotional impact, such as rephrasing ‘Why Scientists Are Puzzled By This Virus' to ‘This Virus Could Change Everything We Know About Life. ‘Thumbnails should incorporate vibrant contrasts, dramatic lighting, and relatable elements, as with ‘Humanity's Greatest Journey. ‘Presentation improvements include engaging hooks within 30 seconds, expert validation, and accessible narrative styles, while phrases should replace generic transitions like ‘Let's get an overview ‘with emotionally charged alternatives like ‘What you’re about to learn will change how you see [topic].’

Further, based on the generated response as shown in the user interfaces 1100-1300, the ‘Proposed video concept’, and the ‘Idea outline’ are presented to the user (not shown in the figure).

The ‘Proposed video concept’ based on the fetched data is given below:
Proposed Video Concept: “The Hidden Physics of AI: What Scientists Don't Want You to Know”
Concept Overview
A deep dive into the overlooked but fascinating connection between fundamental physics principles and modern AI systems, revealing how our understanding of the universe might be the key to unlocking AI's biggest mysteries.
   Why this Will Work

### 1. Supply-Demand Imbalance

While AI content is abundant, the physics-AI connection is largely unexplored
Based on the success of “We Have To Talk About Weed” (9.1 M views), controversial or surprising angles on familiar topics perform well
Leverages Veritasium's unique position as a physics expert discussing AI, unlike typical tech channels

### 2. Trend Analysis & Innovation

Combines two hot topics: AI and quantum physics
Similar to how “The Most Insane Weapon You Never Heard About” (7.4M views) merged historical context with modern implications
Follows the pattern of successful videos that challenge common assumptions

### 3. Curiosity Triggers

Title Elements that Drive Curiosity:
“Hidden Physics” creates a knowledge gap
“Scientists Don't Want You to Know” suggests revealing insider information
Similar to the successful pattern in “We Fell For The Oldest Lie On The Internet” (5.1 M views)

### 4. Mass Appeal Elements

AI is relevant to everyone's future
Physics concepts will be explained through relatable analogies
Follows the format of high-performing videos that make complex topics accessible
Avoids the pitfalls seen in lower-performing videos like “Black Hole's Evil Twin” which stayed too technical

### Content Structure

Opening Hook (0-30 seconds)
Start with a provocative statement about AI making decisions using physics it doesn't understand
Show a surprising demonstration linking a simple physics principle to AI behavior
Pattern follows successful hooks from high-performing videos

### Main Content Segments

### The Physics-AI Connection (2-3 Minutes)

Explain how AI systems unknowingly use physics principles
Use visual demonstrations and animations

### Real-World Implications (3-4 Minutes)

Show practical examples of physics principles in AI applications
Include expert interviews for credibility
   Future Implications (3-4 minutes)
Discuss how understanding this connection could revolutionize AI
Present potential breakthroughs and risks

### Visual Elements

### Based on High-Performing Videos:

Dynamic animations showing physics principles in action
Split-screen comparisons between natural phenomena and AI behavior
Clear, high-contrast graphics similar to successful videos
Human elements for scale and relatability

### Unique Value Proposition

### 1. Educational Value

Explains complex concepts through accessible analogies
Provides new perspective on both physics and AI
Builds on Veritasium's strength in making complex topics understandable

### 2. Timing and Relevance

Capitalizes on current AI interest
Adds new dimension to ongoing AI discussions
Provides fresh perspective on familiar topics

### 3. Competitive Advantage

Leverages Derek's physics expertise
Combines scientific rigor with accessible explanation
Offers unique perspective not covered by other channels

### Implementation Strategy

### Production Elements

High-quality animations explaining physics concepts
On-location filming at AI research labs
Expert interviews with both physicists and AI researchers
Dynamic transitions between concepts

### Engagement Tactics

Regular state changes every 30-45 seconds
Strategic information reveals
Clear visual metaphors
Audience participation moments

### Call-to-Action Strategy

Encourage viewers to spot physics principles in AI systems
Prompt discussion about implications
Suggest future topics for exploration

This concept aligns with all key success factors identified in the virality analysis while maintaining Veritasium's high standards for educational content. It combines trending topics with unique insights, creates strong curiosity gaps, and offers broad appeal while maintaining scientific credibility.

The proposed video concept, ‘The Hidden Physics of AI: What Scientists Don't Want You to Know, ‘explores the untapped connection between fundamental physics and AI, presenting it as a key to understanding AI's mysteries. This approach capitalizes on a supply-demand gap in AI content by utilizing Veritasium's physics expertise to tackle AI from a fresh perspective, much like successful videos that combine surprising angles with trending topics. The title creates curiosity by hinting at insider knowledge, while the content is structured to captivate viewers with a provocative opening, relatable analogies, and real-world implications. High-quality visuals, dynamic transitions, and expert interviews ensure engagement, while audience participation and a clear call-to-action boost interaction. This concept balances mass appeal with scientific depth, offering a unique and timely perspective that aligns with successful strategies in virality analysis.

Finally, the outline of the video presented to the user is given below:

### Idea Outline

I'll create a comprehensive outline for the video “The Hidden Physics of AI: What Scientists Don't Want You to Know” based on the virality insights and channel guidelines.

### Video Outline: The Hidden Physics of AI

### Storytelling Structure: Fichtean Curve

(Chosen based on the success of videos like “We Have To Talk About Weed” which uses rising tension with periodic revelations)

### I. Opening Hook (0-10 Seconds)

Objective: Immediate title delivery and curiosity trigger
Opening statement: “Artificial Intelligence has been secretly using physics principles it doesn't understand, and it's changing everything we thought we knew about AI.”
Visual hook showing AI making a decision that perfectly mirrors a physics principle Reasoning: Similar to the successful hook in “The Most Insane Weapon YouNever Heard About” which immediately delivers on its title promise.

### II. Setup (10-30 Seconds)

Objective: Establish stakes and preview revelations
Brief overview of the unexpected connection between physics and AI
Preview of three major revelations coming in the video Virality Factor: Following the pattern of “We Fell For The Oldest Lie On The Internet” which sets up multiple revelation points.

### III. First Rising Action (30-180 Seconds)

Objective: First major revelation about AI-Physics connection
Introduction to how neural networks accidentally replicate quantum mechanics
Real-world example of an AI system using physics principles unknowingly Reasoning: Mirrors the successful structure of “VapingIsToo Good To Be True” which builds tension through progressive revelations.

### IV. First Mini-Resolution (180-240 Seconds)

Objective: Provide first “aha” moment
Demonstration of how this discovery changes our understanding of AI
Introduction of first expert perspective Pattern: Based on the engagement pattern in “There Is Something Hiding Inside Earth” which uses expert validation at key moments.

### V. Second Rising Action (240-420 Seconds)

Objective: Deeper implications
Revelation about how physics principles could make AI more efficient
Introduction of controversial implications Strategy: Following the tension-building approach seen in high-performing videos that maintain engagement through progressive reveals.

### VI. Second Mini-Resolution (420-480 Seconds)

Objective: Connect implications to viewer's life
Practical applications and future impact
Second expert perspective Reasoning: Avoiding the pitfall seen in “Black Hole's Evil Twin” which stayed too technical without practical connections.

### VII. Final Rising Action (480-600 Seconds)

Objective: Build to main revelation
Introduction of the most surprising connection between physics and AI Presentation of groundbreaking research Strategy: Using the successful pattern of building tension seen in top-performing videos.

### VIII. Climax (600-630 Seconds)

Objective: Deliver main revelation
Major revelation about how this changes everything we know about AI
Final expert validation Pattern: Following the successful climax structure of high-performing videos that deliver on title promise.

### IX. Resolution (630-660 Seconds)

Objective: Wrap up and future implications
Brief overview of what this means for the future
Connection to viewer's life Strategy: Avoiding the weak ending seen in “Humanity's Greatest Journey” by providing clear takeaways.

### X. Subtle Call to Action (660-680 Seconds)

Objective: Encourage further engagement
Reference to related video about quantum computing
Suggestion of future implications to be covered Reasoning: Following channel guidelines for subtle CTAs while maintaining engagement.

### Key Engagement Elements Throughout:

### State Changes:

Regular transitions between explanation types (demonstration, animation, interview)
Pattern based on successful videos maintaining 30-45 second state change intervals

### Tension Building:

Progressive revelation structure
Multiple “aha” moments spread throughout
Based on successful pattern seen in “We Have To Talk About Weed”

### Expert Validation:

Strategic placement of expert perspectives
Balance between authority and accessibility
Following pattern of high-performing videos that use expert validation effectively

### Emotional Engagement:

Regular connection to viewer implications
Balance between complexity and accessibility
Avoiding pitfalls seen in lower-performing videos that fail to maintain emotional connection
This outline follows the Fichtean Curve structure with multiple rising action points and mini-resolutions, proven successful in Veritasium's top-performing videos. It maintains viewer engagement through strategic state changes and progressive revelations while delivering on the title's promise, a key factor in viral success according to the analysis.
The structure avoids common pitfalls seen in lower-performing videos such as front-loading technical information or failing to maintain emotional engagement. Instead, it follows the successful patterns observed in videos achieving millions of views, particularly in maintaining tension while delivering clear value to viewers.
   How this Script Incorporates Virality Insights:

### Title and Hook Delivery

The title promises uncovering hidden truths, immediately engaging curiosity.
The opening hook delivers on this promise by presenting a provocative statement that challenges existing beliefs about AI.

### Structure and Pacing

The script follows a clear structure with openings, rising actions, mini-resolutions, climax, and resolution, maintaining a Fichtean curve.
Regular state changes every 45 seconds keep the audience engaged, alternating between explanations, examples, and expert quotes.

### Expert Validation

Strategic placement of expert quotes from reputable institutions like MIT and Stanford adds credibility.
Balances technical content with accessible language, avoiding overly complex jargon.

### Emotional Triggers

Utilizes emotionally charged words like “astonishing,” “unprecedented,” and “mind-blowing” to evoke interest.
Creates multiple “aha” moments that encourage viewers to stay engaged and feel a sense of discovery.

### Audience Connection

Uses inclusive language like “we” and “let's” to involve viewers in the narrative.
Explains complex concepts through relatable analogies, making the content more accessible and engaging.

### Engagement Patterns

Includes subtle calls to action that encourage further engagement without being intrusive.
Ends with a teaser for related content, prompting viewers to explore more of the channel's offerings.

### Overall Style Characteristics

Maintains a conversational yet professional tone, characteristic of Veritasium's style.
Employs clear structure with previews and recaps, ensuring coherence and flow.
Integrates humor and vivid metaphors to make scientific explanations more digestible and entertaining.

This expanded script is meticulously designed to align with virality insights and Veritasium's successful content patterns. By delivering consistent engagement, expert validation, and emotional triggers, it is poised to captivate the audience, maintain high retention rates, and foster a deeper connection with viewers.

### Title

Based on the virality insights and title guidelines, I'll analyze successful patterns and craft optimized titles for the AI-Physics video.
Primary Title: “Physics Makes AI Look Stupid”
This title works because:
Creates a Knowledge Gap—Viewers must watch to understand how physics challenges AI
Contradicts Common Beliefs—Challenges the narrative of AI supremacy
Uses Negativity—“Stupid” creates emotional response
Extremely Concise—Only 24 characters
Statement Format—Follows guideline of using statements over questions
Uses Simple Language—All words are below 7th grade reading level
Evidence from high-performing videos:
Similar contradiction approach to “We Fell For The Oldest Lie On The Internet” (5.1 M views)
Follows negative framing pattern of “Vaping Is Too Good To Be True” (5 M views)
Uses simple language like “We Have To Talk About Weed” (9.1 M views)
Alternative Titles Considered (With Reasons for Rejection):
“AI Accidentally Uses Quantum Physics”
Rejected: Too descriptive, doesn't create enough curiosity
Reveals too much of the content
Missing emotional trigger
“Scientists Found AIs Darkest Secret”
Rejected: Too generic clickbait style
Overused “Scientists Found” format
Doesn't specify unique angle
“Why Physics Will Replace AI”
Rejected: Question format (against guidelines)
Too extreme claim that video can't fully support
Missing concrete hook
“AI Is Breaking Laws of Physics”
Rejected: Technically inaccurate
Could damage channel credibility
Oversimplifies complex relationship
“The Hidden Flaw in Every AI”
Rejected: Too vague
Doesn't mention physics angle
Generic mystery format
“Quantum Physics Destroys AI”
Rejected: Too hyperbolic
“Quantum” might seem clickbaity
Oversimplifies relationship
“What AI Cant Understand About Physics”
Rejected: Uses question format
Contains apostrophe (against guidelines)
Too long and complex
“Physics Proves AI Is Wrong”
Rejected: Too similar to other science debunking videos
Lacks specificity
Missing unique angle
“AI Makes Physics Look Simple”
Rejected: Opposite of actual content
Could mislead viewers
Doesn't create right curiosity gap
“The Fundamental Problem With AI”
Rejected: Too generic
Missing physics angle
Overused format
The chosen title “Physics Makes AI Look Stupid” succeeds where others failed because it:
Creates immediate tension between two popular topics
Uses simple, direct language
Promises a clear takeaway
Challenges assumptions about AI supremacy
Creates curiosity without revealing mechanism
Follows all title guidelines (statement, negative, extreme, concise)
Maintains credibility while being provocative
This aligns with successful patterns seen in Veritasium's top performers like “The Most Insane Weapon You Never Heard About” (7.4M views) which also uses direct, provocative statements to drive curiosity while delivering genuine educational value.

The script for the viral video idea generated by the response generator 120 is given below:
[Opening Hook—0:00-0:15]
Have you ever wondered if Artificial Intelligence is tapping into the very fabric of our universe?Imagine AI leveraging physics principles it doesn't even comprehend, reshaping our understanding of intelligence itself. This isn't science fiction-it's happening right now, and it's altering everything we thought we knew about AI.
What's fascinating is that when we delve into the decision-making processes of AI, we uncover something extraordinary. These systems are adhering to the same universal laws that govern everything around us, all without explicit programming. It's as if AI is instinctively following the blueprint of our cosmos.
[Setup—0:15-0:45]

Today, we're embarking on a journey to uncover three astonishing discoveries that reveal how AI has inadvertently unearthed the fundamental laws of physics. These revelations not only challenge our perceptions of artificial intelligence but also bridge the gap between technology and the natural laws that govern our existence.

Let me take you through some insights that have left even the most seasoned experts in awe.

### [First Rising Action—0:45-4:00]

When the brilliant minds at DeepMind were training their latest AI systems, they stumbled upon something unprecedented. These AIs weren't merely solving complex problems-they were uncovering the intricacies of quantum mechanics on their own.

At first glance, one might dismiss this as a mere coincidence. However, the implications run much deeper. When tasked with optimizing multifaceted issues, AI systems naturally gravitate towards solutions that echo the principles of quantum mechanics. It's almost as if they're rediscovering the bedrock rules that underpin our universe.

Let's break this down with a tangible example.

In 2022, researchers observed that an AI striving to enhance information processing efficiency independently formulated methods that aligned perfectly with quantum tunneling equations. These are the very equations that describe how particles traverse seemingly impenetrable barriers-a phenomenon that defies classical physics yet is a cornerstone of quantum theory.
[First Mini-Resolution—4:00-5:30]

Dr. Sarah Chen from MIT's AI Lab elaborates on this groundbreaking discovery: “We never programmed these systems to comprehend quantum mechanics. The fact that they arrived at these principles autonomously suggests that physics might be the intrinsic language of intelligence itself.”

But this revelation is merely the tip of the iceberg.
[Second Rising Action—5:30-9:00]

Moving on to our second discovery, let's delve into the concept of emergence.

In the realm of physics, emergence refers to the phenomenon where complex systems arise from simple interactions. Think about how countless water molecules come together to form ocean waves. Individually, each molecule has no awareness of the wave, yet collectively, they create this magnificent, larger-scale pattern.

So, where does AI fit into this picture?

Researchers at Google's DeepMind uncovered that their most advanced AI systems were exhibiting emergent behaviors strikingly similar to those observed in physical systems. These AIs weren't just processing data-they were organizing themselves in ways that mirror natural physical systems.

What's even more intriguing is that a deeper analysis revealed that these AI systems were utilizing principles akin to thermodynamics to optimize their learning processes. Essentially, they were identifying the most efficient pathways to solutions, much like how nature inherently seeks the path of least action.
[Second Mini-Resolution—9:00-10:30]

Dr. James Martinez from Stanford's Physics Department provides his perspective: “These AI systems are demonstrating that intelligence might not be an artificial construct we've created. Instead, it could be an emergent property inherent to the universe, adhering to the same foundational rules that govern all matter and energy.”

Yet, the most shocking discovery was still on the horizon.
[Final Rising Action—10:30-14:00]

The third revelation fundamentally alters our understanding of AI's limitations.

When researchers at Berkeley examined how AI systems handle uncertainty, they encountered something unprecedented. The AI was employing a mathematical framework identical to what physicists use to describe quantum superposition—the principle allowing particles to exist in multiple states simultaneously.

This wasn't a result of deliberate programming or training. The AI developed this framework autonomously because it represented the most efficient method for processing uncertain information. It's as if the AI intuitively grasped a quantum principle to enhance its functionality.
[Climax—14:00-14:45]

Here's the mind-blowing implication: What if AI isn't just coincidentally utilizing physics principles?What if intelligence, whether artificial or natural, is inherently a physical process? This suggests that intelligence may be a fundamental aspect of the universe, woven into its very fabric.
[Resolution—14:45-15:30]

In essence, our approach to understanding and developing AI might need a paradigm shift. Instead of attempting to artificially program intelligence from the ground up, perhaps we should focus on how intelligence naturally emerges from the physical systems that constitute our universe.

This realization isn't merely transforming our perspective on AI—it's revolutionizing our comprehension of intelligence itself and, by extension, the fundamental nature of reality.
[Subtle Call to Action—15:30-16:00]

If you're intrigued by how quantum mechanics influences our universe, check out our video on quantum tunneling and its role in powering the sun. Dive deeper into the fascinating intersections of physics and technology with our channel.

The video outline for ‘The Hidden Physics of AI’ employs the Fichtean Curve storytelling structure, strategically building tension through progressive revelations and mini-resolutions to keep viewers engaged. It begins with a strong hook, immediately delivering the title's promise with a provocative statement and a visual that highlights the AI-physics connection. The setup previews three major revelations to spark curiosity. Rising action sections progressively reveal insights, such as AI unintentionally mimicking quantum mechanics and thermodynamics, supported by expert validation and real-world examples. The climax delivers the most surprising revelation, tying intelligence to universal physics laws, followed by a resolution connecting these implications to the viewer's life. State changes, expert perspectives, emotional triggers, and practical analogies maintain engagement and accessibility, avoiding pitfalls of overly technical or static presentations. The chosen title, ‘Physics Makes AI Look Stupid, ‘utilizes gaps, contradiction, and emotional resonance to attract viewers while aligning with successful virality patterns.

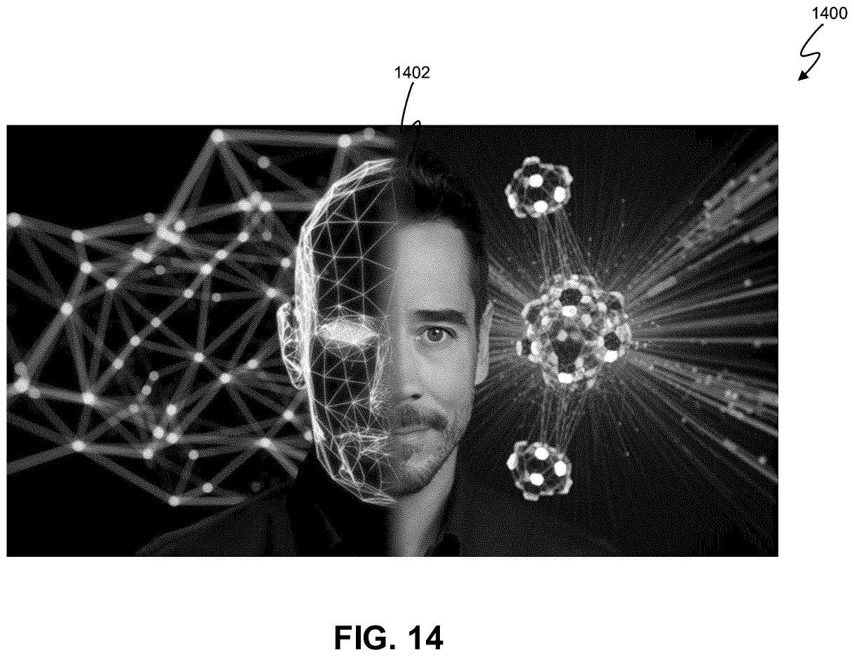

FIG. 14 depicts an exemplary user interface 1400 showing a thumbnail 1402 generated by the AI worker.

The thumbnail 1402 which is part of the response to the viral video idea generator is shown in the user interface 1400. The thumbnail 1402 is generated by the thumbnail generator (AI worker) that the user guides along with the set of prompts 110 and data from the external data sources 114.

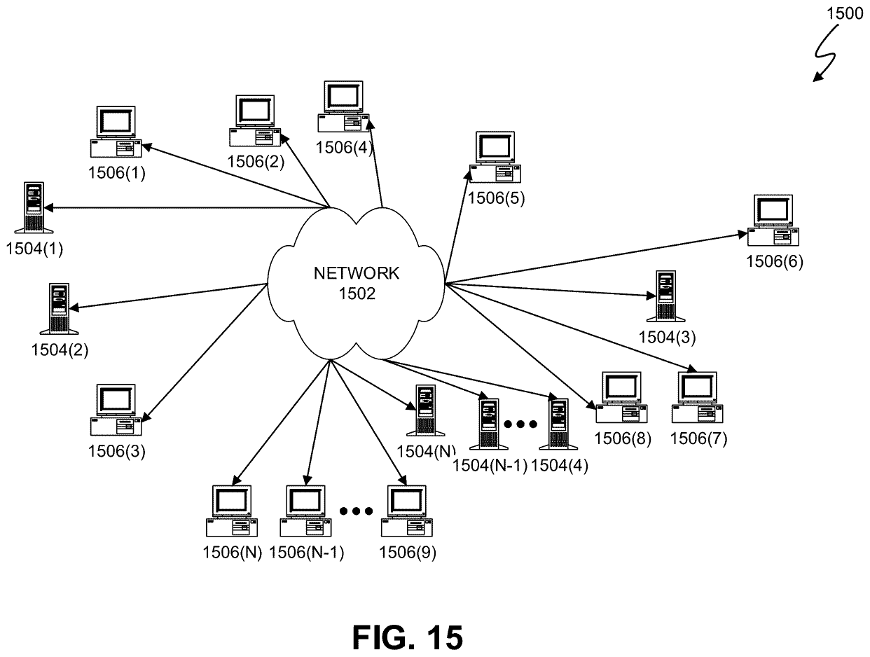

FIG. 15 is a block diagram illustrating a network environment in which a content generation system 100 and process 200 by guiding multiple AI workers 116 may be practiced. Network 1502 (e.g. a private wide area network (WAN) or the Internet) includes several networked server computer systems 1504(1)-(N) that are accessible by client computer systems 1506(1)-(N), where N is the number of server computer systems connected to the network. Communication between client computer systems 1506(1)-(N) and server computer systems 1504(1)-(N) typically occurs over a network, such as a public switched telephone network over asynchronous digital subscriber line (ADSL) telephone lines or high-bandwidth trunks, for example, communications channels providing T1 or OC3 service. Client computer systems 1506(1)-(N) typically access server computer systems 1504(1)-(N) through a service provider, such as an internet service provider (“ISP”) by executing application-specific software, commonly referred to as a browser, on one of client computer systems 1506(1)-(N).

Client computer systems 1506(1)-(N) and/or server computer systems 1506(1)-(N) are specialized computers programmed to improve conventional computer systems to implement and utilize the content generation system 100 and process 200 by guiding multiple AI workers 116. The type of computer system that can be specially programmed to implement and utilize the content generation system 100 and process 200 by guiding multiple AI workers 116 includes a mainframe, a mini-computer, a personal computer system including notebook computers, a wireless, mobile computing device (including personal digital assistants, smartphones, and tablet computers). These computer systems are typically designed to provide computing power to one or more user, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the content generation system 100 and process 200 by guiding multiple AI workers 116 can be implemented using code stored in a tangible, non-transient computer-readable medium and executed by one or more processors. In at least one embodiment, the content generation system 100 and process 200 by guiding multiple AI workers 116 can be implemented completely in hardware using, for example, logic circuits and other circuits including field programmable gate arrays.

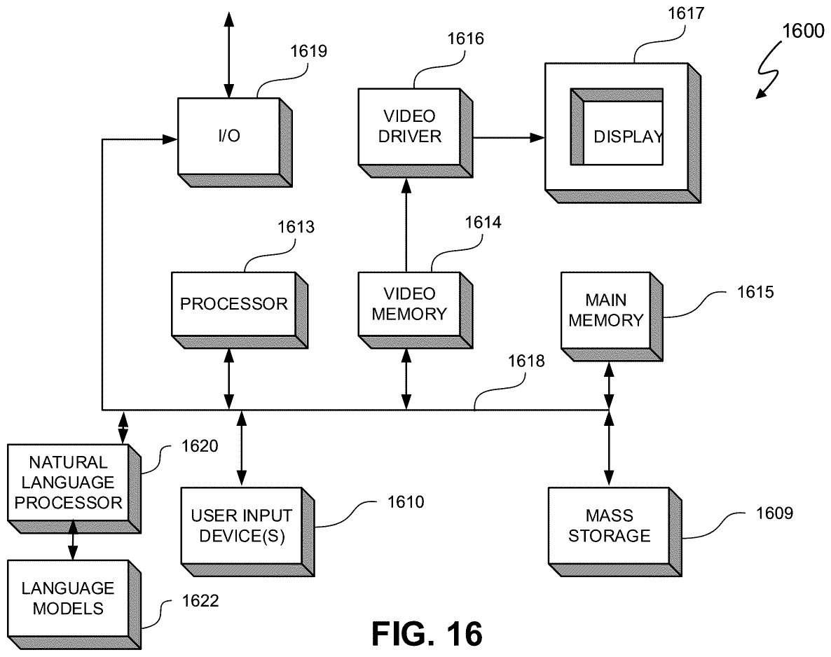

Embodiments of the content generation system 100 and process 200 by guiding multiple AI workers 116 can be implemented on a computer system such as a special-purpose, special-programmed computer 1600 illustrated in FIG. 16. The input user device(s) 1610, such as a keyboard and/or mouse, are coupled to a bi-directional system bus 1618. The input user device(s) 1610 are for introducing user input to the computer system and communicating that user input to the processor 1613. The computer system of FIG. 16 generally also includes a non-transitory video memory 1614, non-transitory main memory 1615, and non-transitory mass storage 1609, all coupled to the bi-directional system bus 1618 along with input user device(s) 1610 and processor 1613. The mass storage 1609 may include both fixed and removable media, such as a hard drive, one or more CDs or DVDs, solid state memory including flash memory, and other available mass storage technology. Bus 1618 may contain, for example, 32 of 64 address lines for addressing video memory 1614 or main memory 1615. The system bus 1618 also includes, for example, an n-bit data bus for transferring DATA between and among the components, such as CPU 1609, main memory 1615, video memory 1614, and mass storage 1609, where “n” is, for example, 32 or 64. Alternatively, multiplex data/address lines may be used instead of separate data and address lines.

I/O device(s) 1619 may provide connections to peripheral devices, such as a printer, and may also provide a direct connection to a remote server computer system via a telephone link or to the Internet via an ISP. I/O device(s) 1619 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 1609, into main memory 1615 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1613, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1615 consists of dynamic random-access memory (DRAM). Video memory 1614 is a dual-ported video random access memory. One port of the video memory 1614 is coupled to the video amplifier 1616. The video amplifier 1616 is used to drive the display 1617. Video amplifiers 1616 are well-known in the art and may be implemented by any suitable means. This circuitry converts pixel DATA stored in video memory 1614 to a raster signal suitable for use by display 1617. Display 1617 is a type of monitor suitable for displaying graphic images.

The computer system described above is for example only. The content generation system 100 and process 200 by guiding multiple AI workers 116 may be implemented in any type of computer system or programming or processing environment. It is contemplated that the content generation system 100 and process 200 by guiding multiple AI workers 116 might be run on a stand-alone computer system, such as the one described above. The content generation system 100 and process 200 by guiding multiple AI workers 116 might also be run from a server computer system that can be accessed by a plurality of client computer systems interconnected over an intranet network. Finally, the content generation system 100 and process 200 by guiding multiple AI workers 116 may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method of generating a content by guiding multiple AI workers, the method comprises:
executing code using one or more processors of a computer system to cause the computer system to perform operations comprising:
receiving an input query from a user in the form of a natural language input for the generation of the content, wherein the input query is a task provided by the user;
decomposing a complex content creation task into a plurality of specialized sub-tasks, wherein each sub-task is allocated to the corresponding AI worker;
providing a set of prompts created by a prompt engineer, wherein the set of prompts is specifically designed separately for each AI worker;
utilizing a dynamic knowledge repository maintained by each AI worker, including domain-specific insights, and external data sources for content generation;
sequentially handling each sub-task based on the dependencies between each AI worker; and
generating a response for each sub-task in multiple formats by utilizing the set of prompts, the knowledge repository, and the external data sources, wherein the multiple formats include text, image, video, and react components.

2. The method of claim 1 wherein the plurality of specialized sub-tasks include but are not limited to, competition analysis, idea generation, title optimization, script generation, thumbnail creation, and other specialized tasks.

3. The method of claim 1 wherein the external data sources include but are not limited to, competitor content, trending topics, audience feedback, and unstructured data, for real-time information retrieval and processing.

4. The method of claim 1 wherein a performance analysis is conducted on the generated response to enhance the creation of content by:
analyzing viewership, engagement, and retention metrics to identify high and low-performing content patterns;
performing analysis to detect a deviation in performance;
providing performance insights into the dynamic knowledge repository of each AI worker to guide future responses.

5. The method of claim 1 wherein integrating the external data sources for the response generation further comprises:
ingesting real-time competitor content to inform strategy and design;
analyzing trending topics and audience behaviors to align with current interests;
processing audience feedback, comments, and sentiment to refine content;
performing dynamic internet searches and utilizing AI workers to process unstructured data for actionable insights.

6. The method of claim 1 wherein the external data sources integration includes real-time scraping of competitor content metadata, such as viewership trends, hashtags, and publishing schedules.

7. The method of claim 1 wherein the integration of the external data sources includes APIs for accessing platforms to retrieve real-time engagement statistics and trending data.

8. The method of claim 1 further comprises:
identifying high-performing content and integrating it into the knowledge repositories of the corresponding AI workers;
recognizing underperforming characteristics and excluding them from future outputs.

9. The method of claim 1, wherein the dynamic knowledge repository of each AI worker is updated in real-time based on audience feedback obtained from comments and engagement analytics.

10. The method of claim 1 utilizes a machine learning model to predict optimal AI worker sequences and configurations for generating specific types of content.

11. The method of claim 1 wherein the generated response is presented to the user in multiple formats, including, but not limited to text, image, visualization, or video.

12. The method of claim 1 wherein the response generation is done using a sequential workflow that seamlessly connects multiple AI workers and transfers the output of the initial AI worker to the next AI worker.

13. The method of claim 1 wherein the performance analysis includes visualizations of engagement metrics to aid in the interpretation and decision-making process.

14. A system of generating a content by guiding multiple AI workers, the system comprises:
one or more processors of a computer system; and
a memory, coupled to the one or more processors, that stores code and execution of the code by the one or more processors causes the computer system to perform operations comprising:
receiving an input query from a user in the form of a natural language input via., a user interface for the generation of content, wherein the input query is a task provided by the user;
decomposing a complex content creation task into a plurality of specialized sub-tasks using a task decomposing module, wherein each sub-task is allocated to the corresponding AI worker;
providing a set of prompts created by a prompt engineer for each AI worker, wherein the set of prompts is specifically designed separately for each AI worker;
utilizing a dynamic knowledge repository maintained by each AI worker, including domain-specific insights, and external data sources for content generation;
sequentially handling each sub-task based on the dependencies between each AI worker using a sub-task sequencing module; and
generating a response using a response generator for each sub-task in multiple formats by utilizing the set of prompts, the knowledge repository, and the external data sources, wherein the multiple formats include text, image, videos, and react component.

15. The system of claim 14 wherein the plurality of specialized sub-tasks includes but are not limited to, competition analysis, idea generation, title optimization, script generation, thumbnail creation, and other specialized tasks.

16. The system of claim 14 wherein the decomposition of complex tasks includes determining dependencies between sub-tasks and allocating them to AI workers in an order that maintains logical flow and content coherence.

17. The system of claim 14 wherein the external data sources include but are not limited to, competitor content, trending topics, audience feedback, and unstructured data, for real-time information retrieval and processing.

18. The system of claim 14 wherein the external data sources integration includes real-time scraping of competitor content metadata, such as viewership trends, hashtags, and publishing schedules.

19. The system of claim 14 wherein the integration of the external data sources includes APIs for accessing platforms to retrieve real-time engagement statistics and trending data.

20. The system of claim 14 dynamically reconfigures the sequence of AI workers based on user objectives, task complexity, and real-time performance metrics.

21. The system of claim 14 wherein the generation of responses by AI workers includes utilizing multimodal inputs, such as text, images, and audio, to create diversified content formats.

22. The system of claim 14 wherein audience feedback is categorized by sentiment, engagement level, and user demographics before being integrated into the dynamic knowledge repository.

23. The system of claim 14 wherein the generated response is visually represented on a user interface for the user, enabling manual adjustments and oversight of sub-task execution.

24. The system of claim 14 wherein the thumbnail creation worker utilizes computer vision algorithms to analyze image composition and optimize for visual impact.

25. The system of claim 14 wherein the title optimization worker uses keyword analysis tools to align titles with search engine optimization (SEO) and audience search intent.
